(19) United States
(12) Patent Application Publication
(10) Pub. No.: US 2017/0129044 A1
(43) Pub. Date: May 11, 2017

(54) REAL-TIME MONITORABLE ELECTRODE TIP TESTER AND WELDING SYSTEM INCLUDING THE SAME

(71) Applicant: HUBIS CO., LTD., Daejeon (KR)

(72) Inventor: Myung Jin KIM, Daejeon (KR)

(21) Appl. No.: 14/934,074

(22) Filed: Nov. 5, 2015

(51) Int. Cl. B23K 11/30; B23K 11/11

(52) U.S. Cl. CPC B23K 11/30; B23K 11/115

(57) ABSTRACT

An electrode tip tester for spot welding comprises a main body, a test block connected to the main body and including a first hole and a second hole facing each other, a camera, a first light source disposed between the first hole and the second hole, a second light source disposed between the first hole and the second hole, a mirror disposed between the upper and lower holes in the test block, and a controller determining at least one of whether there the electrode tip has a defect or damage or the diameter of the electrode tip based on the first image and the second image.

### TECHNICAL FIELD

The present disclosure concerns spot welding, and more specifically, to real-time monitorable electrode tip testers and welding systems including the same.

### DISCUSSION OF RELATED ART

Spot welding is a process in which contacting metal surfaces are joined by the heat obtained from resistance to electric current.

Work-pieces are held together under pressure exerted by electrodes. The process uses two shaped copper alloy electrodes to concentrate welding current into a small spot and to simultaneously clamp the sheets together. Forcing a large current through the spot will melt the metal and form the weld. The attractive feature of spot welding is that a lot of energy can be delivered to the spot in a very short time. That permits the welding to occur without excessive heating of the remainder of the sheet.

Spot welding is used in various fields, such as automobile industry.

FIG. 1 illustrates a welding gun 1 for spot welding. The welding gun 1 includes a pair of shanks 1a facing each other and positioned to enable the distance therebetweea to be adjusted and electrode tips 2 respectively coupled to the respective ends of the shanks 1a.

Each electrode tip 2 has a tip surface 2a that is flat and an arc surface 2b around the tip surface 2a. The diameter of the tip surface 2a may be critical in the welding quality. As welding is repeatedly performed, the electrode tip 2 may experience contamination, damage, and an increase in its diameter that may deteriorate the welding quality.

An electrode tip tester may be used to examine the state or condition of the electrode tip by obtaining a captured image of the electrode tip.

For example, conventional electrode tip testers fail to present an image that clearly shows the outline of the tip surface 2a and thus cannot correctly measure the diameter of the electrode tip.

To precisely measure the diameter of the electrode tip, it may be required to obtain images captured in two directions.

It, however, may result in interference with the welding process by the welding system.

Thus, there is a need for an electrode tip tester that may present a clearly outlined image of the electrode tip while avoiding interference with the welding process.

### SUMMARY

According to an embodiment of the present disclosure, there is provided a real-time monitorable electrode tip tester comprising a main body including upper and lower holes where a pair of electrode tips, respectively, are placed so that the respective tip surfaces of the electrode tips are directed to an inside of the main body, the electrode tips facing each other and coupled to a welding gun, a camera disposed in the inside of the main body, a light-receiving axis of the camera being substantially perpendicular to a straight line connecting the upper and lower holes with each other, a visible light source emitting visible light midway between the upper and lower holes, a laser emitting a laser beam midway between the upper and lower holes, a mirror disposed between the upper and lower holes to reflect the visible light and the laser beam to the electrode tips and reflect images of the electrode tips to the camera so that a visible light image and a laser beam image are captured by the camera, and a controller detecting a contaminated or damaged portion of the electrode tips from the visible light image and the diameter of the electrode tips from the laser beam image to determine whether the electrode tips have a defect.

The mirror rotates to allow the camera to alternately capture images of the electrode tips.

A half mirror is provided on the light-receiving axis of the camera to reflect the visible light from the visible light source to the mirror so that an optic axis of the visible light and the light-receiving axis of the camera are substantially identical to each other.

The laser emits a line beam, and wherein the controller detects the diameter of the electrode tips by an optical triangulation method from the laser beam image.

The laser emits two parallel line beams, and wherein the controller detects the two line beams from the laser beam image to obtain an outline of an edge of one of the electrode tips from four points bent at the edge and then detects the diameter of the electrode tip.

The two parallel line beams are generated as a single line beam is obliquely radiated from the laser to a semi-transparent mirror.

The controller performs control to rotate the mirror and obtain the visible light image before the electrode tips are placed in the upper and lower holes and determines whether there is a defect as to alignment of the electrode tips from the visible light image.

At least one strain gauge is provided in a board material positioned on each of the upper and lower holes to measure to pressure applied by the electrode tips.

According to an embodiment of the present disclosure, a welding system comprises as welding robot having a welding gun equipped with electrode tips, a tip dresser polishing the electrode tips, a welding controller controlling the welding robot to perform a welding process and controlling the tip dresser to polish the electrode tips at a predetermined polishing cycle, a welding monitoring apparatus collecting welding monitoring data from the welding controller, and an electrode tip tester communicating with the welding controller. The electrode tip tester may comprise a main body including upper and lower holes where the electrode tips, respectively, are placed so that the respective tip surfaces of the electrode tips are directed to an inside of the main body, the electrode tips facing each other and coupled to a welding gun, a camera disposed in the inside of the main body, a light-receiving axis of the camera being substantially perpendicular to a straight line connecting the upper and lower holes with each other, a visible light source emitting visible light midway between the upper and lower holes, a laser emitting a laser beam midway between the upper and lower holes, a mirror disposed between the upper and lower holes to reflect the visible light and the laser beam to the electrode tips and reflect images of the electrode tips to the camera so that a visible light image and a laser beam image are captured by the camera, and a controller detecting a contaminated or damaged portion of the electrode tips from the visible light image and the diameter of the electrode tips from the laser beam image to determine whether the electrode tips have a defect, wherein the welding controller controls the electrode tip tester to test the electrode tips at least one of after the electrode tips are polished, during a welding standby time, or after a predetermined number of times of welding are performed, receive a result of the test to determine whether to polish the electrode tips, and wherein the welding monitoring apparatus receives and monitors the test result from the welding controller, and the welding monitoring apparatus generates information for process management including at least one of welding history management, analysis of a correlation between the welding monitoring data and the test result, setting a polishing cycle, management of welding quality, tracing as welding defect, or management of consumption of the electrode tips.

According to an embodiment of the present disclosure, an electrode tip tester for spot welding comprises a main body, a test block connected to the main body and including a first hole and as second hole respectively formed in two opposite surfaces of the test block, an electrode tip being placed adjacent to each of the first hole and the second hole, and the first hole and the second hole facing each other, a camera disposed in the main body, a light-receiving axis of the camera being substantially perpendicular to a straight line connecting the first hole and the second hole with each other, a first light source disposed in the main body and directed to a point between the first hole and the second hole, a second light source disposed in the main body and directed to the point between the first hole and the second hole, a mirror disposed between the upper and lower holes in the test block, the mirror directing a first light beam from the first light source and a second light beam from the second light source to the electrode tip and reflecting the first light and the second light reflected back by the electrode tip to the camera to allow the camera to capture a first image corresponding to the first light beam and a second image corresponding to the second light beam, and a controller determining at least one of whether there the electrode tip has a defect or damage or the diameter of the electrode tip based on the first image and the second image.

The first light is visible light, and the second light is a laser beam.

The mirror is rotated at a predetermined angle in two directions with respect to a shaft.

A semi-transparent mirror is disposed in the main body to create two line beams from a single line beam emitted from the second light source.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIG. 1 is a view illustrating a spot welding gun according to the related art;

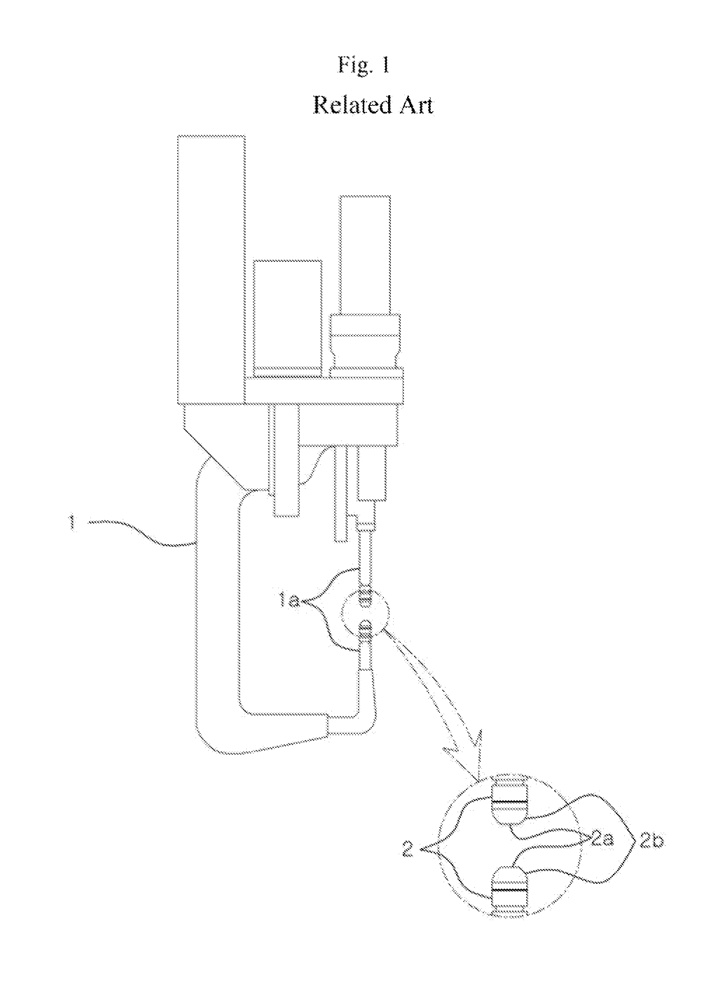

FIG. 2 is a perspective view illustrating a real-time monitorable electrode tip tester according to an embodiment of the present disclosure;

FIG. 3 is a perspective view illustrating a real-time monitorable electrode tip tester according to an embodiment of the present disclosure, wherein (a) of FIG. 3 illustrates an example before an electrode tip is placed in a hole of a testing block, and (b) of FIG. 3 illustrates an example after the electrode tip is placed in the hole of the testing block;

FIG. 4 is a perspective view illustrating a real-time monitorable electrode tip tester according to an embodiment of the present disclosure, wherein (a) of FIG. 4 illustrates an example in which a mover for rotating a mirror is separated, and (b) of FIG. 4 illustrates an example in which a main body is removed;

FIG. 5 is a side view illustrating the inside of a real-time monitorable electrode tip tester according to an embodiment of the present disclosure;

FIG. 6 is a side view illustrating the inside of the real-time monitorable electrode tip tester of FIG. 5, with a mirror rotated clockwise at 90 degrees. according to an embodiment of the present disclosure;

FIGg. 7 is a plan view illustrating the inside of a real-time monitorable electrode tip tester according to an embodiment of the present disclosure;

FIG. 8 is a view illustrating light reflected when a laser beam is incident onto a translucent mirror, according to an embodiment of the present disclosure;

FIG. 9 is a view illustrating an example of a laser beam image captured by a camera according to an embodiment of the present disclosure; and

FIG. 10 is a view illustrating a configuration of a welding system according to embodiment of the present disclosure.

### DETAILED DESCRIPTION OF EXEMPLARY EMBODIMENTS

Hereinafter, exemplary embodiments of the inventive concept will be described in detail with reference to the accompanying drawings. The inventive concept, however, may be modified in various different ways, and should not be construed as limited to the embodiments set forth herein. As used herein, the singular forms “a ,” “an,” and “the” are intended to include the plural forms as well, unless the context clearly indicates otherwise. It will be understood that when an element or layer is referred to as being “on,” “connected to,” “coupled to,” or “adjacent to” another element or layer, it can be directly on, connected, coupled, or adjacent to the other element or layer, or intervening elements or lavers may be present.

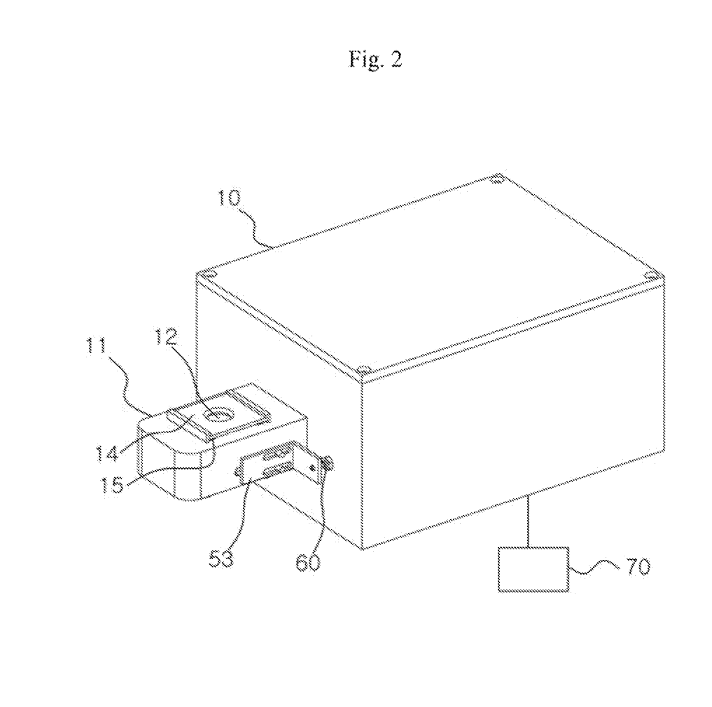

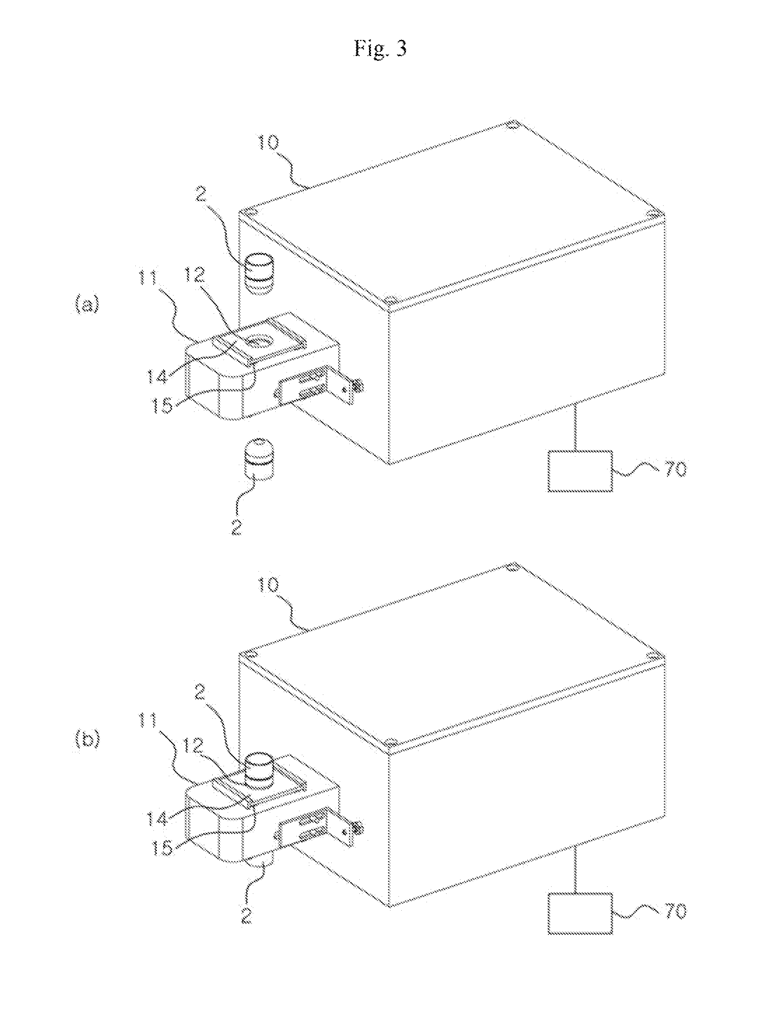

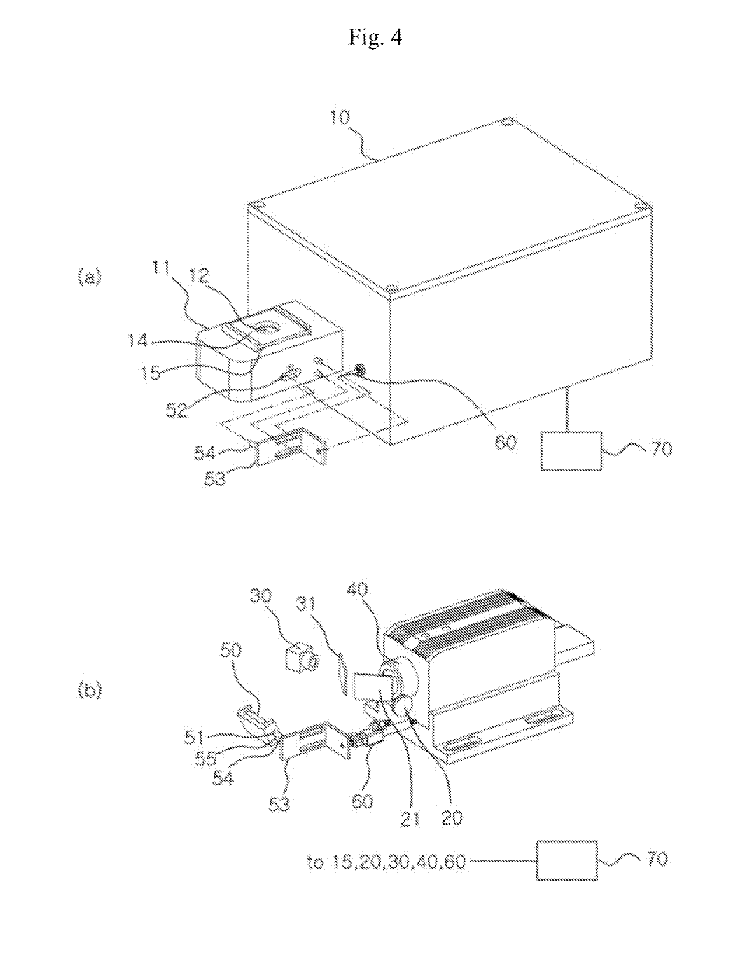

FIG. 2 is a perspective view illustrating a real-time monitorable electrode tip tester according to an embodiment of the present disclosure. FIG. 3 is a perspective view illustrating a real-time monitorable electrode tip tester according to an embodiment of the present disclosure, wherein (a) of FIG. 3 illustrates an example before an electrode tip is placed in a hole of a testing block, and (b) of FIG. 3 illustrates an example after the electrode tip is placed in the hole of the testing block. FIG. 4 is a perspective view illustrating a real-time monitorable electrode tip tester according to an embodiment of the present disclosure, wherein (a) of FIG. 4 illustrates an example in which a mover for rotating a mirror is separated, and (b) of FIG. 4 illustrates an example in which a main body is removed.

According to an embodiment of the present disclosure, the real-time monitorable electrode tip tester may be an apparatus that may test the electrode tip of a welding system (e.g., a spot welding gun) to determine, e.g., the diameter of the tip surface 2a of the electrode tip, contamination or damage to the tip, or pressure or alignment of the tip. According to an embodiment of the present disclosure, the electrode tip tester may include a main body 10 including a visible light source 20, a laser 30, a camera 40, and a driving cylinder 60 in an internal space thereof, a testing block 11 integrally formed with the main body 10 and projecting frontward from the main body 10, and a controller 70 controlling the operation of the components in the main body 10.

The testing block 11 includes upper and lower holes 12 and 13 positioned opposite each other in a vertical direction. The internal space ofthe testing block 11 is continuous to the internal space of the main body 10. A mirror 50 is disposed between the upper and lower holes 12 and 13.

A pair of electrode tips 2 facing each other and equipped in the welding gun 1 are placed in the upper and lower holes 12 and 13, respectively, and at least the tip surface 2a of each electrode tip 2 is directed to the internal space of the testing block 11. For example, when the upper electrode tip 2 is fitted into the upper hole 12, and the lower electrode tip 2 is fitted into the lower hole 13, the arc surfaces 2b around the tip surfaces 2a of the electrode tips 2 are partially contacted and stuck by the upper and lower holes 12 and 13, and the tip surfaces 2a are rendered to face each other through the internal space of the testing block 11.

To measure a pressure applied by the electrode tips 2 placed in the upper and lower holes 12 and 13, board materials 14 are provided on the top and bottom, respectively, of the testing block 11, and strain gauges 15 are positioned at four corners of each board material 14. The upper and lower holes 12 and 13 are formed to pass through the board materials 14. The pressure applied by the electrode tip 2 when the electrode tip 2 is placed may be measured by the strain gauges 15. The testing block 11 may have holes corresponding in position to the upper and lower holes 12 and 13 formed through the board materials 14. The pressure sensed by the strain gauges 15 is transferred to the controller 70. The controller 70 may obtain or measure the pressure applied by the electrode tip 2 when the electrode tip 2 is placed in the hole 12 or 13 based on forces applied to the four corners of the board material 14.

The mirror 50 is disposed midway between the upper and lower holes 12 and 13. The mirror 50 may be rotated by a rotational shaft 51 so that the reflective surface may be inclined up or down at 45° with respect to the direction to the internal space of the main body 10.

The mirror 50 is rotated by a driving cylinder 60.

A mover 53 is provided on a side surface of the testing block 11. The mover 53 may be moved back or forth by the driving cylinder 60. A connecting pin 54 is formed on a front end portion of the mover 53. The connecting pin 54 passes through a restricting hole 52 formed in a side surface of the testing block 11 and is fitted, with a room, through a pin bole 55 formed in a side surface of the mirror 50.

The restricting hole 52 may be a slot formed long in a front-to-rear direction (e.g., a horizontal direction of the testing block 11) to restrict the range of rotation of the mirror 50 to, e.g., 45° upward and, e.g., 45° downward. The pin hole 55 may be formed on a lower or higher level than the rotational shaft 51 and may be formed to have an upper-to-lower diameter larger than the diameter of the connecting pin 54, so that as the connecting pin 54 moves back and forth, the mirror 50 may be rotated.

The driving cylinder 60 may adopt, e.g., a pneumatic cylinder or hydraulic cylinder.

Accordingly, as the driving cylinder 60 runs to move the connecting pin 54 from an end of the restricting hole 52 to the other, the mirror 50 is rotated up at 45° with respect to the direction to the internal space of the main body 10 and then down at 45°.

Thus, an image of the electrode tip 2 placed in the upper hole 12 and an image of the electrode tip 2 placed in the lower bole 13 may be alternately reflected by the mirror 50 to the internal space of the main body 10 in a direction substantially perpendicular to the line connecting the upper and lower holes 12 and 13 with each other. When reflected on the mirror 50, the incident angle becomes 45°, and the reflection angle becomes 45°. Thus, the angle between the incident light and the reflected light becomes 90°.

The visible light source 20, the laser 30, and the camera 40 included in the inside of the main body 11 are described below with reference to FIGS. 4 to 7.

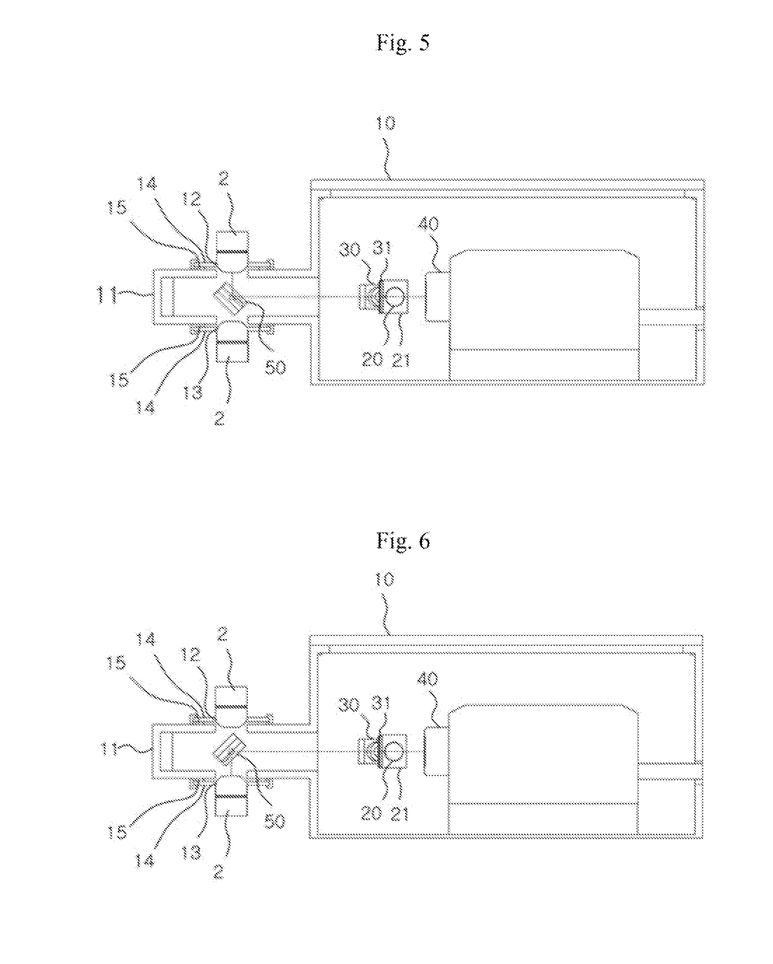

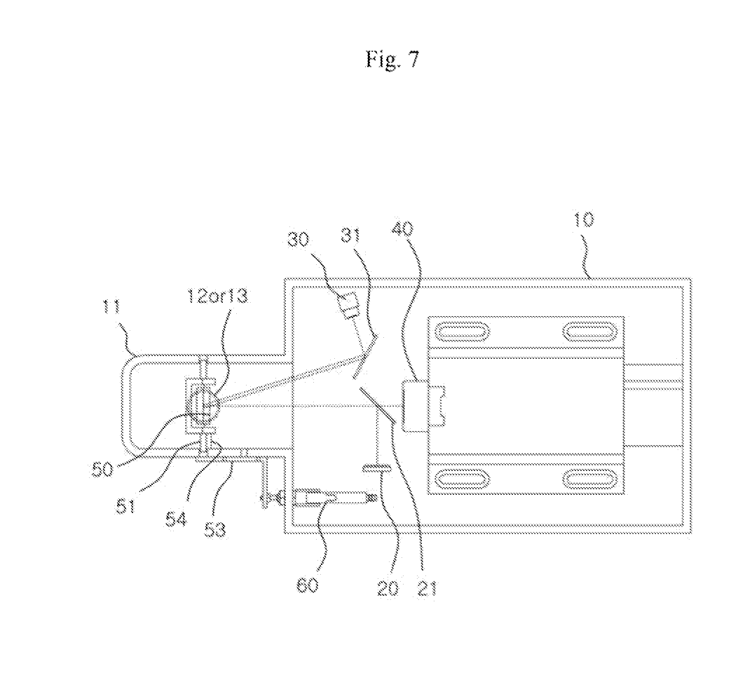

FIG. 5 is a side view illustrating the inside of a real-time monitorable electrode tip tester according to an embodiment of the present disclosure. FIG. 6 is a side view illustrating the inside of the real-time mom torable electrode tip tester of FIG. 5, with a mirror rotated clockwise at 90 degrees, according to an embodiment of the present disclosure. Referring to FIGS. 5 and 6, the minor 50 is oriented up at 45° as shown in FIG. 5, and is rotated down by 90° to be directed down at 45° as shown in FIG. 6. FIG. 7 is a plan view illustrating the inside of a real-time monitorable electrode tip tester according to an embodiment of the present disclosure.

The camera 40 is received in the main body 10 so that the light receiving axis (e.g., the axis of light incident onto the camera 40) is substantially perpendicular to the straight line connecting the upper and lower holes 12 and 13 with each other. An image of the electrode tip 2 is reflected at 90° by the mirror 50 and is captured by the camera 40.

The visible light source 20 radiates visible light midway between the upper and lower holes 12 and 13. Thus, the visible light is reflected by the mirror 50 and irradiates the electrode tip 2. Thus, the image of the electrode tip 2 is reflected by the mirror 50 and is clearly captured by the camera 40.

According to an embodiment of the present disclosure, a half mirror 21 is provided to be inclined at 45° with respect to the optic axis of the image captured by the camera 40, and the visible light source 20 emits visible light to the half mirror 21 to have an incident angle of 45°. The optic axis of the visible light radiated to the mirror 50 is identical to the optic axis of the image captured by the camera 40. In other words, coaxial illumination may apply. For example, the optical system for irradiating the electrode tip 2 through the half mirror 21 has the same optic axis as the optical system for capturing the image of the electrode tip 2.

As such, application of the coaxial illumination allows light to be regularly reflected on the clear flat surface of the electrode tip 2 so that a brighter image may be captured by the camera 40 while causing irregular reflection on edges or boundaries of contaminated or defective areas so that a darker image may be captured by the camera 40. Accordingly, a visible image may be obtained that allows defective or dirty areas to be clearly noticed. Further, by applying the coaxial illumination, the visible light source 20 may be equipped in a smaller space, thus allowing the main body 10 to be made compact.

The laser 30 radiates a laser beam midway between the upper and lower holes 12 and 13. The laser beam is reflected by the mirror 50 to the electrode tip 2. The laser beam is then sequentially reflected by the electrode tip 2 and the mirror 50 into the camera 40. The camera 40 captures an image by the laser beam.

As such, according to an embodiment of the present disclosure, the mirror 50 reflects visible light from the visible light source 20 and as laser beam from the laser 30 to the electrode tip 2 and then reflects the visible light and laser beam reflected back to the laser 30 by the electrode tip 2 into the camera 40. Thus, the camera 40 may capture a visible light image and a laser beam image for the electrode tip 2.

The laser 30 may be provided to measure the diameter of the tip surface 2a by detecting the shape of the electrode tip 2 via an optical triangulation method using laser beams. The laser 30 radiates a laser beam to the mirror 50 at a position departing from the optic axis of the optical system constituting the camera 40 (e.g., the optic axis of the image captured by the camera 40). Thus, there occurs a non-zero angle between the incident angle of the laser beam incident onto the tip surface 2a of the electrode tip 2 and the reflection angle of the laser beam reflected on the tip surface 2a.

Three-dimensional shape measuring using the optical triangle method basically uses the principle that the position of an image formed on the image surface of the light receiving system is changed depending on the surface level by leaving an angle between the light incident onto an object and the light reflected on the object.

By the laser radiation as set forth above, there may be obtained an image that allows the observer or user to more clearly identify the boundary between the tip surface 2a of the electrode tip 2 and the arc surface 2b extending to the tip surface 2a.

According to an embodiment of the present disclosure, the laser beam may be a line beam or slit beam.

According to an embodiment of the present disclosure, one line beam may be emitted from the laser 30, and two parallel line beams may be reflected by the mirror 50 into the electrode tip 2.

For example, a semitransparent mirror 31 may be provided close to the half mirror 21, so that one laser beam emitted from the laser 30 is radiated to the semitransparent mirror 31 in an inclined direction and is reflected by the semitransparent mirror 31 into the mirror 50.

The semitransparent mirror 31 may feature creation of light reflections on its front and rear surfaces that may be visibly recognized or noticed. The semitransparent mirror 31 may have substantially the same reflectance on the front and rear surfaces thereof.

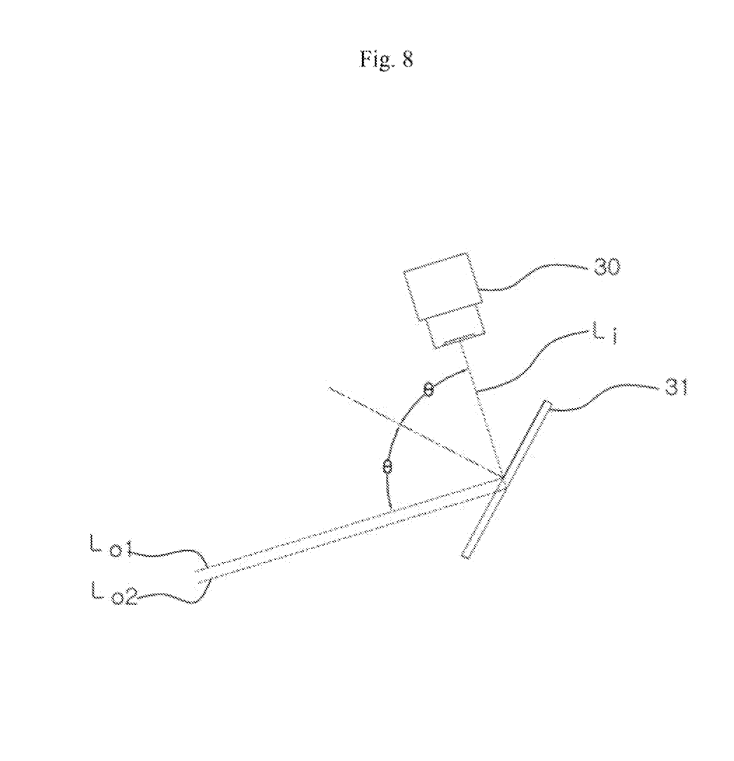

Referring to FIG. 8, when a laser beam Lᵢ is obliquely incident onto the semitransparent mirror at θ°, a reflection Lₒ₁ is created on the front surface of the semitransparent mirror 31, and a reflection Lₒ₂ is created on the rear surface of the semitransparent mirror 31 by the incident laser beam having passed through the semitransparent mirror 31, resultantly producing two reflections Lₒ₁ and Lₒ₂. When the incident laser beam is a line beam, two parallel line beam reflections are produced.

Since the two parallel line beams are reflected by the mirror 50 into the electrode tip 2, the laser beam image captured by the camera 40 is rendered to have two line beams. The direction in which the laser 30 radiates the line beam or the incident angle and reflection angle of the semitransparent mirror 31 may be adjusted to allow the two parallel line beams to pass through the tip surface 2a.

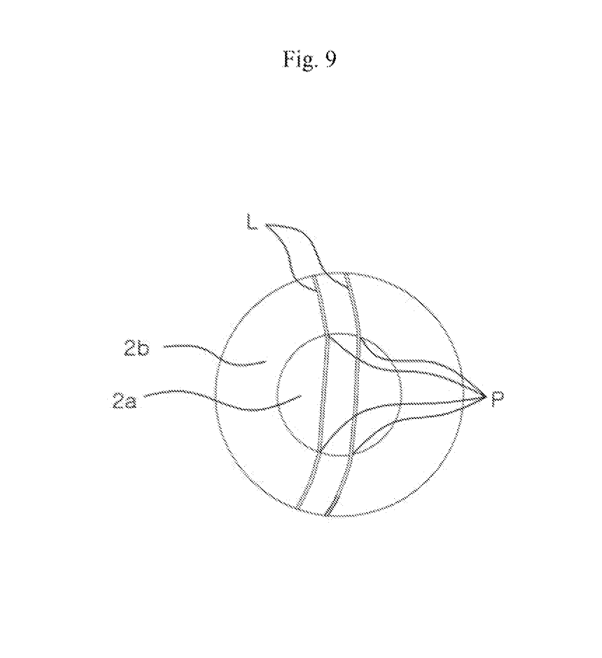

FIG. 9 is a view illustrating an example of a laser beam image captured by a camera according to an embodiment of the present disclosure. Referring to FIG. 9, the controller 70 may detect the two line beams L that are bent on the edge of the tip surface 2a of the electrode tip 2 (e.g., boundary between the tip surface 2a and the arc surface 2b) to obtain four points P and may compute the diameter of a circle formed by the four points P. The circle may correspond to the outline of the edge of the tip surface 2a and thus the diameter of the circle may be substantially the same as the diameter of the tip surface 2a.

Referring to FIG. 9, when the line beam is radiated in a direction forming a predetermined angle with respect to the direction of a normal line to the tip surface 2a, the camera 40 may produce a line beam image for the electrode tip 2, where the line beam is bent on the boundary between the 2a and the arc surface 2b.

Image capturing is performed by arranging the mirror 50 and the half mirror 21 above and making visible light regularly reflected on the tip surface 2a of the electrode tip 2 by way of coaxial illumination. Accordingly, a contaminated or defected area may be correctly detected through an image captured as such. The tip surface 2a is detected by the optical triangulation method using the laser 30 emitting one line beam and the semitransparent mirror 31 producing two line beam reflections from the one line beam. Thus, the diameter of the tip surface 2a may be precisely obtained.

Under the typical test condition where the distance between the electrode tips needs to be about 30 mm when testing the electrode tips, it may be difficult to properly illuminate the electrode tips. However, according to an embodiment of the present disclosure, the mirror 50 is positioned in the testing block 11 where the electrode tips are placed, so that illumination and image capturing are carried out by way of coaxial illumination. Thus, the tester may be configured compact enough to meet the test condition. Thus, the tester according to the present disclosure may be used in site without interfering with the welding robot.

The tester configured as above may test the alignment of the electrode tips, pressure applied by the electrode tips, and contamination or damage to the electrode tips, or diameter of the tip surface of the electrode tip under the control of the controller 70.

The welding gun 1 is moved by the welding robot, and the pair of electrode tips 2 are aligned to the upper and lower holes 12 and 13 of the testing block 11. The pair of electrode tips 2 are moved closer to each other and are placed in the upper and lower holes 12 and 13, respectively. The controller 70 operates in association with the operation of the welding gun 1, as follows.

The controller 70 rotates the mirror 50 before the electrode tips 2 are placed in the upper and lower holes 12 and 13 and controls the driving cylinder 60 and the camera 40 to obtain visible light images of the electrode tips 2. The respective images of the electrode tips 2 may be captured through the upper and lower holes 12 and 13 by the camera 40, and in this case, visible light may be radiated from the visible light source 20.

The controller 70 may check the alignment of the electrode tips 2 by detecting the overall outline and the position of a center of the tip surface 2a as the tip surface 2a is viewed from the front thereof from the visible light image of the electrode tips 2 obtained before the electrode tips 2 are in place. In other words, the controller 70 may detect the angle at which the electrode tip 2 is inclined from the shape of the outline. When the outline forms a circle, the controller 70 may determine that the electrode tip 2 is not inclined, and when the inclined angle exceeds a predetermined value, the controller 70 may determine that a defect occurred. Alternatively, the controller 70 may determine whether there is a defect by checking the position of the center of the electrode tip 2 when welding is performed, or the controller 70 may determine whether there is a defect by detecting the degree of misalignment between the respective central axes of the electrode tips 2.

When the pressure detected by the strain gauges 15 when the electrode tips 2 are placed in the upper and lower holes 12 and 13 does not meet a predetermined reference value, the controller 70 may determine that there is a defect.

The controller 70 may control the visible light source 20, the laser 30, the camera 40, and the driving cylinder 60 to sequentially performing the operations of radiating visible light and a laser beam to the electrode tip 2 placed in the upper hole 12 to capture an image and radiating visible light and a laser beam to the electrode tip 2 placed in the lower hole 13 to capture an image. Accordingly, the controller 70 receives, from the camera 40, the visible light image and the laser beam image of each of the electrode tips 2.

The controller 70 may detect a contaminated or damaged portion of the electrode tip 2 from the visible light image to determine whether there is a defect due to the contamination and damage, and the controller 70 may detect the diameter of the tip surface 2a from the laser beam image to determine whether the diameter of the tip surface 2a is within a predetermined size.

According to an embodiment of the present disclosure, there may be a predetermined time gap between the radiation of the visible light and the radiation of laser beam to the electrode tip 2, so that the visible light image and the laser beam image may be sequentially obtained.

Alternatively, a single visible light-laser beam image may be captured by simultaneously radiating the visible light and laser beam to each electrode tip 2 to determine whether there is a defect. In this case, the single visible light-laser beam image may contain a visible light image and a laser beam image overlapping the visible light image. The controller 70 may detect contaminated or damaged portions separately for each position of the tip surface 2a and the arc surface 2b based on partitioning information on the tip surface 2a and the arc surface 2b obtained by reading the laser beam image.

According to an entodiment of the present disclosure, the electrode tip tester may include a communication port to communicate with a welding controller for interworking with a welding system.

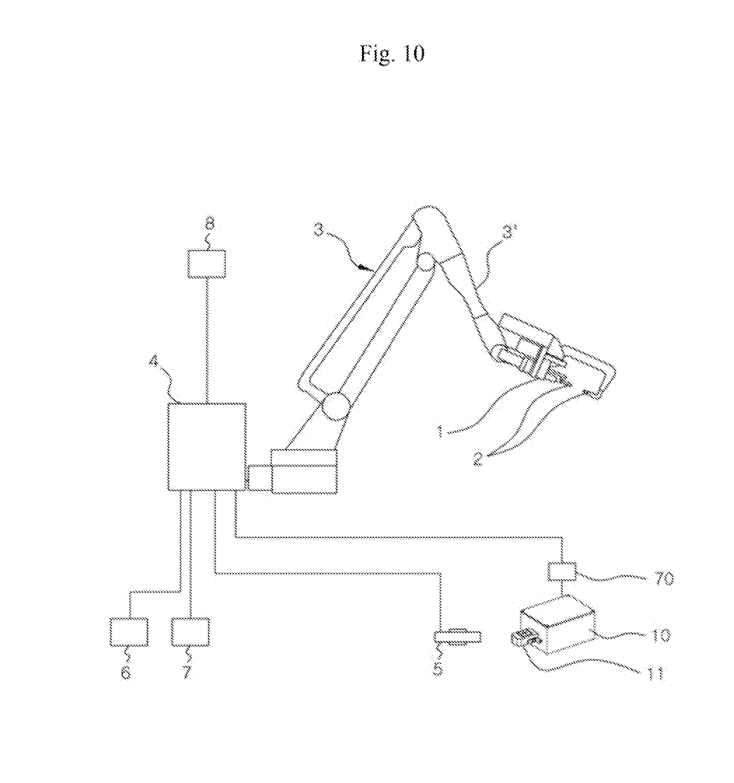

FIG. 10 is a view illustrating a configuration of a welding system according to an embodiment of the present disclosure.

A welding system includes a welding robot 3 including an arm 3′ equipped with a welding gun 1, a current supplying device 6 supplying electric current for welding (simply referred to as a welding current), a coolant supplying device 7 for adjusting the temperature of the electrodes, a tip dresser 5 for polishing the electrode tips 2, a welding controller 4 for controlling an overall welding process including the operation of the welding robot 3, supply of the welding current, circulation of the coolant (e.g., cooling water), and polishing the electrode tips, and a welding monitoring device 8 for collecting and monitoring, in real-time, welding monitoring data, including a welding voltage, welding current, pressure applied upon welding, temperature of electrode or welding state or condition, via the welding controller 4 and managing the welding process and welding quality.

According to an embodiment of the present disclosure, the welding system may include an electrode tip tester coupled to communicate with the welding controller 4.

Timings when tests are performed by the electrode tip tester may be set in the welding controller 4.

The electrode tip tester may perform a test when the electrode tips 2 are moved to the testing block 11 at a test timing as set in the welding controller 4 under the control of the welding controller 4. Test results including a result of determination, contaminated or damaged portions, diameter of the tip surface 2a and the magnitude of pressure, may be transferred to the welding controller 4 via the communication port and may be applied to the operation for managing the electrode tips (e.g., polishing operation), and the test results may be transferred to the welding monitoring device 8 to be managed as records and utilized as material for process management.

For example, the test timing may be set to be after the electrode tips are polished by the tip dresser, to a welding standby time, or after a predetermined number of times of welding are performed.

The test result obtained at the test timing may be transferred via the communication port to the welding controller 4, and the welding controller 4 may determine and perform subsequent control operations depending on the test result as follows.

When determining based on the test result after polishing that the polished state is proper or polishing has been properly done, the welding controller 4 may perform welding using the electrode tips, and when detecting a contaminated or damaged portion or when the diameter of the tip surface 2a departs from a predetermined reference value, the welding controller 4 may control the tip dresser 5 to perform polishing again.

Upon determining that the state of the electrode tips is not proper from the test result after a predetermined number of times of welding are performed or during the welding standby time while the welding is performed, the welding controller 4 may control the tip dresser 5 to perform re-polishing and then re-testing, and when determining the state of the electrode tips is otherwise proper, the welding controller 4 performs a welding process.

When determining from the test result that the electrode tips are misaligned, the welding controller 4 may inform a worker or operator of the misalignment, e.g., by sounding an alarm.

The test result may be transferred in real-time to the welding monitoring device 8. The welding monitoring device 8 may monitor the test result in real-time to manage the history and analyze the correlation between welding monitoring data and the test result to generate material for process management, such as, e.g., setting an optimal polishing period, management of welding quality, tracing defects, or management of consuming electrodes, and utilize the generated material for process management.

For example, the variations in state of the electrode tip testers that may be caused by repeated welding may be grasped to reset the polishing cycle, the state of the electrode tips may be made to match the welding monitoring data to ensure welding quality, the state of electrode tips may be used to trace the cause of welding defects, and the degree of consumption of the electrode tips due to welding may be obtained and used for process management.

While the inventive concept has been shown and described with reference to exemplary embodiments thereof, it will be apparent to those of ordinary skill in the art that various changes in form and detail may be made thereto without departing from the spirit and scope of the inventive concept as defined by the following claims.

What is claimed is:

1. A real-time monitorable electrode tip tester, comprising:
a main body including upper and lower holes where a pair of electrode tips, respectively, are placed so that the respective tip surfaces of the electrode tips are directed to an inside of the main body, the electrode tips facing each other and coupled to a welding gun;
a camera disposed in the inside of the main body, a light-receiving axis of the camera being substantially perpendicular to a straight line connecting the upper and lower holes with each other;
a visible light source emitting visible light midway between the upper and lower holes;
a laser emitting a laser beam midway between the upper and lower holes;
a mirror disposed between the upper and lower holes to reflect the visible light and the laser beam to the electrode tips and reflect images of the electrode tips to the camera so that a visible light image and a laser beam image are captured by the camera; and
a controller detecting a contaminated or damaged portion of the electrode tips from the visible light image and the diameter of the electrode tips from the laser beam image to determine whether the electrode tips have a defect.

2. The real-time monitorable electrode tip tester of claim 1, wherein the mirror rotates to allow the camera to alternately capture images of the electrode tips.

3. The real-time monitorable electrode tip tester of claim 2, wherein a half mirror is provided on the light-receiving axis of the camera to reflect the visible light from the visible light source to the mirror so that an optic axis of the visible light and the light-receiving axis of the camera are substantially identical to each other.

4. The real-time monitorable electrode tip tester of claim 1, wherein the laser emits a line beam, and wherein the controller detects the diameter of the electrode tips by an optical triangulation method from the laser beam image.

5. The real-time monitorable electrode tip tester of claim 4, wherein the laser emits two parallel line beams, and wherein the controller detects the two line beams from the laser beam image to obtain an outline of an edge of one of the electrode tips from four points bent at the edge and then detects the diameter of the electrode tip.

6. The real-time monitorable electrode tip tester of claim 5, wherein the two parallel line beams are generated as a single line beam is obliquely radiated from the laser to a semi-transparent mirror.

7. The real-time monitorable electrode tip tester of claim 1, wherein the controller performs control to rotate the mirror and obtain the visible light image before the electrode tips are placed in the upper and lower holes and determines whether there is a defect as to alignment of the electrode tips from the visible light image.

8. The real-time monitorable electrode tip tester of claim 1, wherein at least one strain gauge is provided in a board material positioned on each of the upper and lower holes to measure a pressure applied by the electrode tips.

9. A welding system, comprising:
a welding robot having a welding gun equipped with electrode tips;
a tip dresser polishing the electrode tips;
a welding controller controlling the welding robot to perform a welding process and controlling the tip dresser to polish the electrode tips at a predetermined polishing cycle;
a welding monitoring apparatus collecting welding monitoring data from the welding controller; and
an electrode tip tester communicating with the welding controller, the electrode tip tester comprising:
a main body including upper and lower holes where the electrode tips, respectively, are placed so that the respective tip surfaces of the electrode tips are directed to an inside of the main body, the electrode tips facing each other and coupled to a welding gun;
a camera disposed in the inside of the main body, a light-receiving axis of the camera being substantially perpendicular to a straight line connecting the upper and lower holes with each other;
a visible light source emitting visible light midway between the upper and lower holes;
a laser emitting a laser beam midway between the upper and lower holes;
a mirror disposed between the upper and lower holes to reflect the visible light and the laser beam to the electrode tips and reflect images of the electrode tips to the camera so that a visible light image and a laser beam image are captured by the camera; and
a controller detecting a contaminated or damaged portion of the electrode tips from the visible light image and the diameter of the electrode tips from the laser beam image to determine whether the electrode tips have a defect, wherein the welding controller controls the electrode tip tester to test the electrode tips at least one of after the electrode tips are polished, during a welding standby time, or after a predetermined number of times of welding are performed, receive to result of the test to determine whether to polish the electrode tips, and wherein the welding monitoring apparatus receives and monitors the test result from the welding controller, and the welding monitoring apparatus generates information for process management including at least one of welding history management, analysis of a correlation between the welding monitoring data and the test result, setting a polishing cycle, management of welding quality, tracing a welding defect, or management of consumption of the electrode tips.

10. An electrode tip tester for spot welding, comprising:
a main body;
a test block connected to the main body and including a first hole and a second hole respectively formed in two opposite surfaces of the test block, an electrode tip being placed adjacent to each of the first hole and the second hole, and the first hole and the second hole facing each other;
a camera disposed in the main body, a light-receiving axis of the camera being substantially perpendicular to a straight line connecting the first hole and the second hole with each other;
a first light source disposed in the main body and directed to a point between the first hole and the second hole;
a second light source disposed in the main body and directed to the point between the first hole and the second hole;
a mirror disposed between the upper and lower holes in the test block, the mirror directing a first light beam from the first light source and a second light beam from the second light source to the electrode tip and reflecting the first light and the second light reflected back by the electrode tip to the camera to allow the camera to capture a first image corresponding to the first light beam and a second image corresponding to the second light beam; and
a controller determining at least one of whether there the electrode tip has a defect or damage or the diameter of the electrode tip based on the first image and the second image.

11. The electrode tip tester of claim 10, wherein the first light is visible light, and the second light is a laser beam.

12. The electrode tip tester of claim 10, wherein the mirror is rotated at a predetermined angle in two directions with respect to a shaft.

13. The electrode tip tester of claim 10, wherein a semi-transparent mirror is disposed in the main body to create two line beams from a single line beam emitted from the second light source.
